(19) United States
(12) Patent Application Publication
(10) Pub. No.: US 2014/0284382 A1
(43) Pub. Date: Sep. 25, 2014

(54) RANDOM-TYPE MULTILAYER IDENTIFICATION, AND SYSTEM USING SAME

(71) Applicant: Kwang-don Park, Seoul (KR)

(72) Inventor: Kwang-don Park, Seoul (KR)

(21) Appl. No.: 14/345,516

(22) PCT Filed: Oct. 7, 2011
(86) PCT No.: PCT/KR2011/007453

§ 371 Date: Mar. 18, 2014

(30) Foreign Application Priority Data
Oct. 26, 2010 (KR) 10-2010-0104828
Dec. 23, 2010 (KR) 10-2010-0133179
Mar. 22, 2011 (KR) 10-2011-0025323

(51) Int. Cl. G06K 19/06; G06F 21/34

(52) U.S. Cl. CPC G06K 19/06037; G06F 21/34; G06K 19/06046
USPC 235/380; 235/488

(57) ABSTRACT

A random-type multilayer identifier uses an identification pattern that is formed by irregularly-dispersed identification particles as unique information and is configured in such a manner that two or more identification layers made out of a transparent material are stacked each other, and besides, has an advantage that significantly reduces the duplication possibility of an existing identifier provided in a printed manner, such as a QR code, a barcode, a hologram, etc., because multiple identification layers having the irregularly-dispersed identification particles are stacked each other and recognized as two-dimensional data.

### TECHNICAL FIELD

The present invention relates to a random-type multilayer identifier and an authentication system using same, especially wherein multiple identification layers having irregularly-dispersed are stacked each other, so that a unique overlapped pattern that is prevented from being duplicated is formed, and the overlapped pattern is easily read using a camera module mounted on a widespread Personal Digital Assistant (PDA) or mobile phone, so that user authentication is performed in real time, and thus convenience in use is enhanced.

### BACKGROUND ART

Recently, identifying products, authority, or people has become important when the public performs a number of daily activities, such as a warranty service of a product, a variety of business transactions including a contract, an entering and leaving process, and an access to information.

Labels attached to products, warranties, etc. or identification cards, personal seals, etc. have been used to distinguish genuine products from fake ones or authorized people from the rest and also various keys have been used to allow people to enter or leave, however duplication technology has advanced along with the advancement of scientific technology. Accordingly, another recognition means is increasingly required that is hard to be duplicated. As a result, various types of recognition means, such as a key embedded with a barcode, a smartcode, a magnetic card, a Quick Response (QR) code, a hologram sticker, or an Integrated Circuit (IC) chip, as well as various technologies using physical characteristics, such as fingerprints, irises, face recognitions, etc., have been developed.

However, the above-mentioned technologies have disadvantages and problems as follows; the barcode, IC chip, etc. are duplicable, thereby causing a security concern; the recognition system using physical characteristics, such as a fingerprint recognition, is hard to be duplicable, while having a problem that is used in a limited manner (with regard to the number of users, usable time, and usable space) because parts of the human body are used as identifiers; and the QR code, magnetic card, hologram sticker are easily duplicable, thereby having low security. To solve the disadvantages and problems, the present applicant has obtained a patent on the following invention; Korean Patent registration number 1005242720000, entitled “random-type identifying material, 3-D identifying system and method using the same”.

The invention “random-type identifying material, 3-D identifying system and method using the same” previously filed by the present applicant uses a random-type identifying material to be applied to an identifying system, wherein identification particles of which position values and characteristics are recognized in one or multiple direction(s) using an additional recognition means are irregularly dispersed inside a three-dimensional shape, and the identifying material is made out of a synthetic resin or glass material and configured in such a manner that multiple identification particles formed in a size between some micrometers and millimeters are irregularly dispersed inside the identifying material. The random-type identifying material with such a configuration compares information inputted through the 3-D identifying system with previously-stored information stored in an authentication server so that authentication is performed.

Besides, according to the 3-D identifying system using the random-type identifying material previously filed by the present applicant, an image recognition device for acquiring an image of an object is an essential element that significantly affects recognition efficiency with regard to the object to be recognized, and thus a research on the image recognition device is required.

To solve this, the present applicant has obtained a patent on the following invention: Korean Patent registration number 723036, entitled “3-D image recognition device”. The 3-D image recognition device previously filed by the present applicant recognizes an image in multiple directions at one time, and includes a tube that forms the external appearance thereof, a bent portion that is disposed in the front end of the tube and configured with a sectional prism, a lens unit that is arranged in the rear of the bent portion, and an image recognizer that is arranged in the rear of the lens unit to obtain an image passing through the bent portion and lens unit. Because the bent portion is provided to the front of the lens unit, the 3-D image recognition device with such a configuration may obtain an image of an object observed in various directions, based on refraction angles of light through an image recognizer with either of a Charge Coupled Device (CCD) or Complementary Metal Oxide Semiconductor (CMOS) image sensor, and the obtained image data allows three dimensional position recognition (x, y, and z coordinates recognition) to be performed.

However, although the 3-D image recognition device previously filed by the present applicant is required to exactly and quickly read data with regard to position or characteristic values of identification particles dispersed in an identifier, recognition is performed under condition that light is provided to the identifier as well as distances and angles between the identifier and the lens unit are accurately adjusted, and as a result, the recognition device has disadvantages that are inconvenient in use as well as hard to be widely used due to low usability caused by a decreased recognition rate.

In addition, the conventional 3-D image recognition device has disadvantages that require high costs because the device is integrally provided with the image recognizer including an expensive CCD or COMS image sensor, and are economically hard to be popularized because an additional device is required to authenticate an image obtained through the image recognizer.

Accordingly, the 3-D image recognition device is expensive, large in volume, hard to control, and difficult to carry, and thus, being inadequate for the public to easily authenticate a target object regardless of place and time.

### DISCLOSURE

### Technical Problem

An objective of the present invention is applied to solve the disadvantages of the prior arts and is to provide a random-type multilayer identifier and an authentication system using same which uses a camera, that is, a device that is easily carriable and used to obtain two-dimensional data, to obtain characteristic values of identification particles in a multilayer identifier and allow users to learn that the identifier has multiple layers, and thus, duplication is prevented.

That is, the objective of the present invention is to provide a random-type multilayer identifier and an authentication system using same which configure an identification layer having a unique identification pattern in multiple numbers, so that a user easily determines whether the identifier is genuine by looking the external appearance of the identifier with naked eyes, and also read an image of an overlapped pattern or an identification pattern in the each identification layer to use the read image as authentication information, so that duplication is prevented and a user easily performs authentication using a camera module mounted on a mobile phone, a smartphone, and various PDAs.

### Technical Solution

According to one preferred embodiment of the present invention, the objective is achieved by a random-type multilayer identifier which includes an identification layer that is made out of a transparent material and has an identification pattern formed by irregularly-dispersed identification particles, characterized in that the two or more identification layers are stacked each other to form a unique overlapped pattern.

According to one preferred embodiment of the present invention, an authentication system using the random-type multilayer identifier is characterized in that the system includes an identifier which uses an identification pattern that is formed by irregularly-dispersed identification particles as unique information and is formed in such a manner that two or more identification layers made out of a transparent material are stacked each other, a terminal which is used to photograph the overlapped identification pattern of the identifier and transmits information on the overlapped identification pattern through a wired and wireless network, and then receives result information corresponding to the transmitted information, and an authentication server which receives the information on the overlapped identification pattern transmitted from the terminal, compares the transmitted information with previously-stored information corresponding to the identifier to make a result value, and transmits the result value to the corresponding terminal.

According to one preferred embodiment, the present invention is characterized in that either of a resin material or a glass material, or both of the two materials is used to form the identification layer, the identification particle has a characteristic value configured with any one of position, color, shape, and size, or a combination thereof, and is formed out of any one or more of resin, glass, mineral, and metallic powders or in a printed manner.

According to another preferred embodiment, the present invention is characterized in that an index pattern storing index information is additionally provided to one side of the identifier.

According to a further preferred embodiment, the present invention is characterized in that the multiple stacked identification layers are configured in such a manner that a transparent adhesive layer is disposed between the identification layers so that the one identification layer is detachable from the other opposite identification layer.

According to a further preferred embodiment, the present invention is characterized in that any one of the multiple stacked identification layers is made out of a transparent material having a color different from the rest of the layers.

According to a further preferred embodiment, the present invention is characterized in that the multiple stacked identification layers are provided in the same sizes or in sizes different from each other.

According to a further preferred embodiment, the present invention is characterized in that an opaque blocking layer is provided to the bottom of the identifier with the multiple stacked identification layers.

According to a further preferred embodiment, the present invention is characterized in that the terminal includes a camera module which is used to photograph an image of the identification pattern, a microcomputer module which is connected to the camera module and reads and analyzes the photographed image to convert the analyzed image into data, and a wired and wireless communication module which is connected to the microcomputer module, and receives/transmits the data as well as receives a result value corresponding to the data to feed the result value back to the microcomputer module, wherein the terminal may be any one of a mobile communication terminal, a Personal Computer (PC), a PDA, a Mobile Computer, a handheld PC, an Automated Teller Machine (ATM), and a Retail Teller Machine (RTM).

### Advantageous Effects

The random-type multilayer identifier according to the present invention has an advantage that significantly reduces the duplication possibility of an existing identifier provided in a printed manner, such as a QR code, a barcode, a hologram, etc., because multiple identification layers having irregularly-dispersed identification particles are stacked each other and recognized as two-dimensional data. That is, the identifier of the present invention is configured in such a manner that the multiple identification layers are stacked each other, so that it is impossible to duplicate any one of identification layers configuring a genuine identifier and place the duplicated layer in the original position, and thus, the possibility of duplication is prevented beforehand, and also a user easily recognizes the thickness and volume of the identifier having a multilayer structure, so that it is impossible to duplicate only data values of the identifier. In addition, the present invention has an advantage that increases convenience in use because recognizing the identifier is performed using a camera module mounted on a mobile communication terminal or a PDA in wide use among the public, and especially, has other advantages that has a number of economical benefits and lowers the market entry barrier because the development and spread of additional recognition devices are unnecessary.

Characteristics and advantages are more apparent from the following detailed description of preferred embodiments of the present invention with reference to the attached drawings. Terms and words used in the following description and claims are not limited to the common and dictionary meanings and concepts, but must be understood in meanings and concepts corresponding to the technical ideas of the present invention.

### DESCRIPTION OF DRAWINGS

FIG. 1 illustrates a random-type multilayer identifier according to the present invention in a perspective view.

FIG. 2 illustrates a configuration of the random-type multilayer identifier in FIG. 1 in an exploded perspective view.

FIG. 3 illustrates the random-type multilayer identifier according to the present invention in a top view.

FIG. 4 illustrates the random-type multilayer identifier according to the present invention in a side view.

FIG. 5 illustrates another embodiment of FIG. 4 in a side view.

FIG. 6 illustrates the random-type multilayer identifier that has identification layers formed in sizes different from each other according to the present invention in a perspective view.

FIG. 7 illustrates a configuration of the random-type multilayer identifier that is additionally provided with an index pattern according to the present invention in a perspective view.

FIG. 8 is a block diagram of a configuration of an authentication system using the random-type multilayer identifier according to the present invention.

FIG. 9 illustrates another embodiment of the random-type multilayer identifier according to the present invention in a perspective view.

### DESCRIPTION OF THE REFERENCE NUMERALS IN THE DRAWINGS

1: random-type multilayer identifier

10: identification layer

11: identification particle

13: identification pattern

20: index pattern

30: terminal

### MODE FOR INVENTION

Hereinafter, a random-type multilayer identifier according to the present invention is described with reference to the accompanying drawings, First of all, it is noted that like reference characters indicate like components or parts throughout the drawings. The detailed descriptions of known functions and elements that may unnecessarily make the gist of the present invention obscure are omitted.

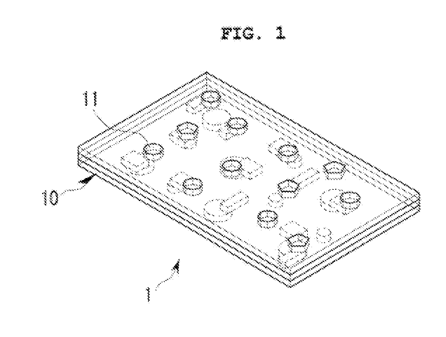

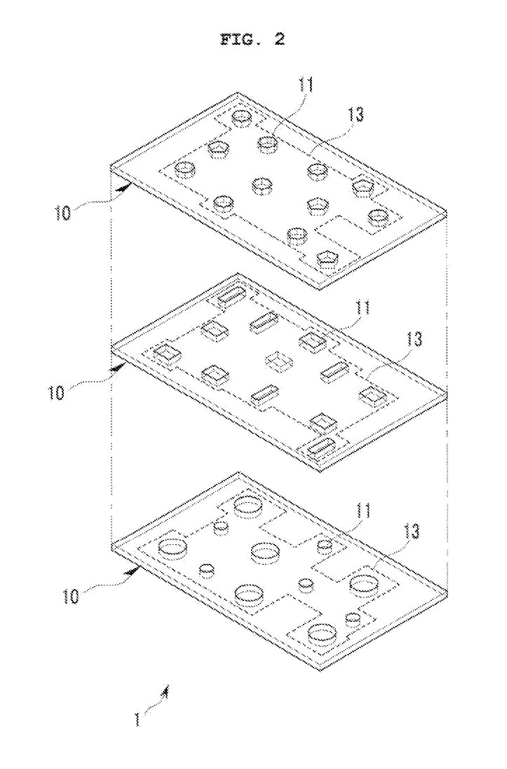

FIG. 1 illustrates a random-type multilayer identifier according to the present invention in a perspective view, and FIGS. 2 to 4 are an exploded perspective view, a top view, and a side view, respectively. As illustrated in FIGS. 1 to 4, a random-type multilayer identifier 1 according to the present invention is configured in such a manner that at least two identification layers 10 are stacked each other, wherein the each identification layer 10 is a plank-shaped member that is made out of a synthetic resin or glass material with light transmission, and has a plurality of identification particles 11 irregularly dispersed therein or on the external surface thereof. That is, a plurality of the colored or magnetic identification particles 11 formed in different sizes are irregularly dispersed inside the each identification layer 10 so that a unique identification pattern 13 is formed, wherein these identification layers 10 may be formed in a molded manner or printed on the surface of a sheet material.

For example, in case of the identification layer 10 formed in a molded manner, either of a resin or glass material is used or both of the two materials are combined with each other to create a basic molding material, and then the basic molding material is mixed with a plurality of identification particles 11 made out of any one or more of synthetic, glass, mineral, and metallic powders, and after that, a hardening process is performed. Here, it is preferable that materials used for the basic molding material and identification particles are different from each other, for example, a synthetic material is used for the basic molding material while a metallic powder is used for the identification particles.

According to another embodiment, in case of the identification layer 10 formed in a printed manner, the identification layer 10 is configured using a printer toner or ink that has identification particles made out of any one or more of synthetic, glass, mineral, and metallic powders, and then the identification layer is printed on a product directly, or a film or material with light transmission.

The identification layer 10 with such a configuration is used as a unique authentication factor, based on the recognition of the following factors: position values on the rectangular coordinate system; sizes; colors; shapes; magnetic characteristic values; and optical characteristic values of the identification particles 11 irregularly dispersed inside or on the external surface of the layer. In addition, when a user touches the identification layer with a finger, the identification layer gives the user a bumpy feeling, which facilitates the user to determine whether the layer is duplicated.

The two or more identification layers 10 with such a configuration according to the present invention are stacked each other to form the identifier 1 of the present invention. That is, according to the present invention, the identifier is configured in such a manner that an identification layer having a unique identification pattern 13 is stacked in numbers more than two, and thus such an identifier has multiple identification patterns 13 stacked each other so that the patterns become an overlapped state, and the overlapped identification patterns 13 are obtained as one image and the obtained one image is used as unique authentication information. Accordingly, it is impossible to exactly duplicate the multiple identification layers 10 having unique identification patterns, respectively and re-arrange the identification patterns of the identification layers 10 in each a manner that the overlapped pattern 3 of the duplicated layers is identical to that of the original layers, and thus, this may be used as a means for determining the genuineness of a product.

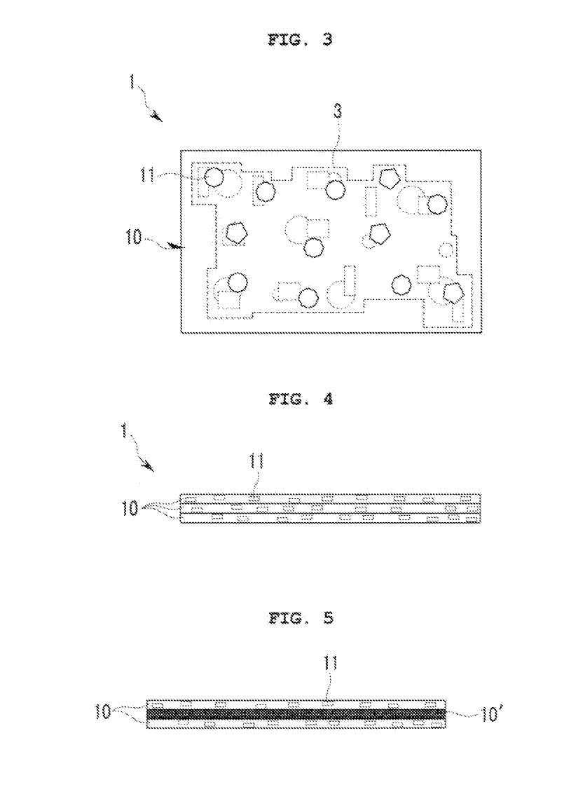

According to the preferred embodiment of the present intention, as shown in FIGS. 1. to 4, there is provided an identifier 1 that is configured in such a manner that identification layers 10 having unique identification patterns 13, respectively are stacked each other. Here, it is preferable that the each identification layer 10 is made out of a transparent or light-transmitting material, and an overlapped pattern 3 is formed as shown in FIG. 3, when the identifier 1 of the present invention is observed from the top. According to the present invention, such an overlapped pattern 3 is provided to be used as unique authentication information, wherein the unique authentication information is a characteristic value generated by any one of positions, colors, shapes, and sizes of identification particles that dispersed in each of the identification layers 10 forming the overlapped pattern 3 or a combination thereof. Besides, using the authentication information will be described below, however, in brief description, a database is constructed using the overlapped pattern 3, and comparison and determination are performed using the overlapped pattern stored in the database when necessary.

FIG. 5 illustrates another embodiment of the random-type multilayer identifier according to the present invention, and according to the another embodiment, there is provided an identifier of which a part is damaged by a user after an authentication process, and thus the identifier is prevented from being reused. To achieve this, the random-type multilayer identifier 1 according to the embodiment of the present invention has an adhesive layer 10′ disposed between two or more identification layers 10 having unique identification patterns 13, respectively, so that the identification layers 10 opposite to each other may be detachable from each other. Here, the adhesive layer 10′ may be provided with an adhesive agent only or another adhesive agent mixed with identification particles.

For example, after the authentication of a random-type identifier attached to a product, a user removes (for example, detaches or cuts) any one of identification layers configuring the identifier, and thus the identifier is prevented from being reused beforehand. That is, in case of a container stopper, the identifier is torn immediately after the stopper is removed, or a user detaches any one of the identification layers or cuts a part of the identifier, and thus the identifier is prevented from being reused. In addition, the identifier in which some of the identification layers are removed may be configured so that limited authentication information is provided using identification patterns or an overlapped pattern formed by the unremoved identification layers.

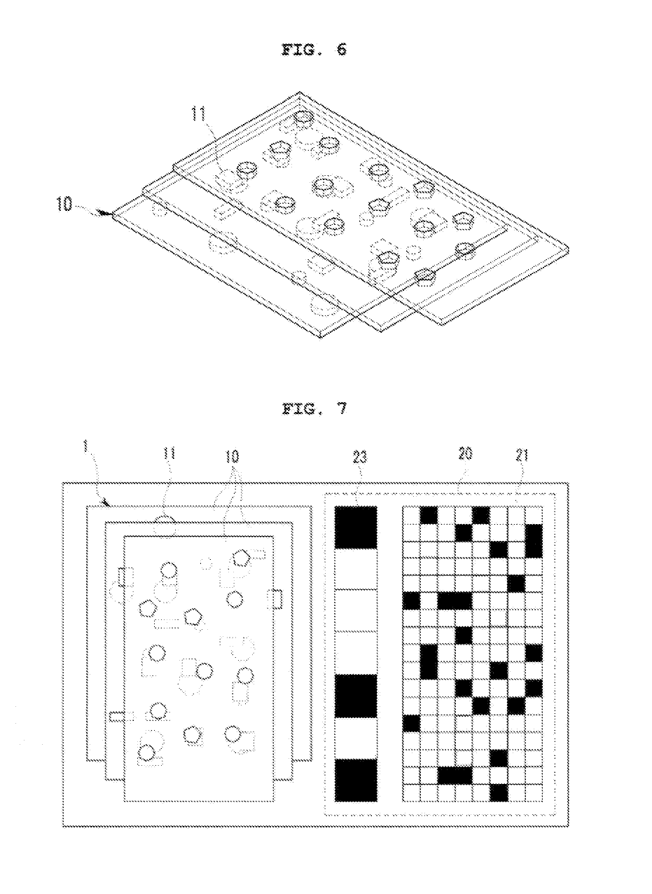

FIG. 6 illustrates the random-type multilayer identifier according to a further embodiment of the present invention in a perspective view. As shown in FIG. 6, an identifier 1 according to the further embodiment has multiple stacked identification layers 10 formed in sizes different from each other. This is because the layers in different sizes allow a user to easily determine whether the identifier is duplicated through a visual check or the appearance as well as to easily remove any one of the multiple identification layers configuring the identifier. Specifically, the top identification layer is bigger than other layers disposed below the top one or has a picking portion protruding from one end thereof so that the user may easily remove the top identification layer.

FIG. 7 is provided to increase reading rate and reliability of the random-type multilayer identifier according to the present invention, and an identifier 1 of the embodiment additionally has an index pattern 20 that stores index information and is provided to one side thereof. Specifically, identification layers 10 configuring the identifier 1 of the present invention are transparent, respectively, and an index pattern 20 on which calling codes are printed is integrally provided to one side of the identifier. Here, the index pattern 20 includes product information that is stored in an overlapped pattern 3 formed by a number of the identification layers 10, for example, basic product information (price, date of manufacture, date of expiration, name of manufacturer, etc.) and data on an Internet Protocol (IP) of an authentication server that provides authentication information of the corresponding product.

Although the index pattern 20 may be formed in the known art, such as a barcode, the present invention provides another configuration which includes a colored grid pattern that has grid squares filled with two or more colors so that color codes are generated through a combination of the colors, and a reference color pattern 23 that is disposed next to the colored grid pattern 21 and is filled with the same colors as the colored grid pattern.

Here, the colored grid pattern 21 configuring the index pattern 20 is configured in such a manner that the grid squares are filled with two or more colors, thereby storing a large quantity of complicated information through a combination of different colors in comparison with the existing case using black-and-white codes. In addition, the reference color pattern 23 is a kind of a reference color table that stores all the colors used for one colored grid pattern 21. The exemplary use of the index pattern 20 is briefly described below. The colored grid pattern 20 has a problem that a difference between recognized image information and previously-stored image information is caused by a performance difference between optical recognition devices such as a camera, a scanner, etc. or photographing conditions (considerably dark or light), or by a discolored state during a distribution process, and thus, it is impossible to use information by means of a combination of different colors. Accordingly, the present invention provides the reference color pattern 23 which allows colors of the colored grid pattern 21 to be read on the basis of color information stored in the reference color pattern 23, and thus the above-mentioned problem caused by the performance difference between optical recognition devices, photographing conditions, and discolored state during a distribution process are solved.

For example, in case that the colored grid pattern 21 is recognized without the reference color pattern 23, although information on the recognized colored grid pattern is required to be compared with previously-stored information (assuming that the previously-stored information is referred to as C, information on an image taken in a dark room is referred to as information A, and another information on an image taken in a light open field is referred to as B), the both information A and B are different from the previously-stored information C, and thus storing and analyzing information using colors fail to be performed. Whereas, according to the present invention, the reference color pattern 23 is provided to one sheet, and thus, providing reference values of colors filled in the colored grid pattern facilitates storing and analyzing information using colors because the colors of the colored grid pattern 21 are recognized with reference to the reference color pattern, even in a state in which photographing lights are changeable or the performance of cameras are different from each other.

Besides, the identifier 1 of the present invention may have an opaque blocking layer (not shown) so that a recognition rate of identification particles forming the overlapped pattern 3 is increased, wherein although it is preferable that the blocking layer is painted with a dark or primary color, a variety of colors may be used to increased a color contrast ratio. In addition, the multiple identification layers 10 configuring the identifier 1 may be made out of a transparent material having colors different from each other, and this is because the colored identification layers allows a user to determine whether a product is duplicated after the user visually checks the appearance of the product.

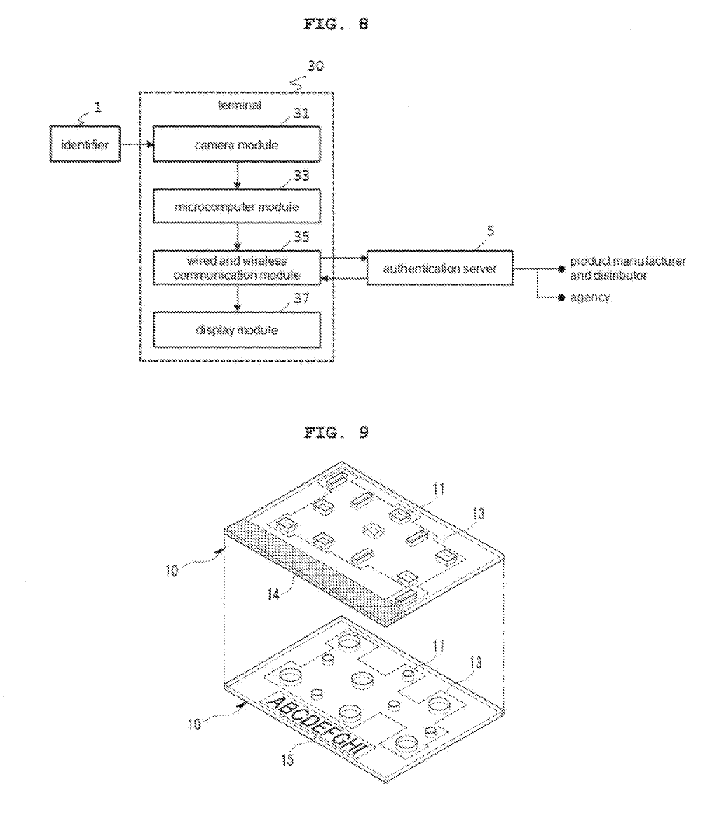

FIG. 8 is a block diagram of a configuration of an authentication system using the random-type multilayer identifier according to the present invention. As shown in FIG. 8, the authentication system according to the present invention includes an identifier 1 which is attached to a product and has authentication information, a terminal 30 which reads the authentication information stored in the identifier 1, and an authentication server 5 which compares and analyzes the authentication information read through the terminal with another previously-stored information to provide a corresponding result value.

The identifier 1 is formed in such a manner that two or more identification layers 10 are stacked each other, wherein each of the identification layers 10 has an identification pattern 13 formed by a number of irregularly-dispersed identification particles 11. That is, the identifier 1 uses an overlapped pattern 3, which is formed by unique identification patterns 13 of the multiple identification layers 10 stacked each other, as unique information. This identifier 1 has a configuration similar to the identifier described with reference to FIGS. 1 to 4, and thus, hereinafter, the repeated description of the identifier is omitted.

The terminal 30 photographs the overlapped pattern 3 formed by the multiple stacked identification layers 10 so as to transmit information on the overlapped pattern to the authentication server 5 connected through a wired and wireless network and receive a result value corresponding to the information, and after that, provides the result values to a user. The terminal 30 with such a configuration includes a camera module 31 which is used to photograph an image of the overlapped pattern 3, a microcomputer module 33 which is connected to the camera module 31, and reads and analyzes the photographed image to convert the read and analyzed image into data, and specifically, analyzes position and characteristic values of identification particles obtained from the overlapped pattern 3, a wired and wireless communication module 35 which is connected to the microcomputer module 33, and receives the analyzed data to transmit the received data to the authentication server 5 to be described below, and then receives a result value corresponding to the data to feed the result value back to the microcomputer module 33, and a display module 37 which is connected to the microcomputer 33 and displays a variety of information on the screen.

Besides, an application, that is, a program that performs an authentication process is installed in the terminal 30, and here, the application is software that is programmed to perform an authentication process and known arts are applied thereto, and thus, the detailed description of the application as omitted. Although a variety of devices are applied to such a terminal 30, it is preferable that a smartphone or a mobile phone in wide use among the public, and also a PC, a PDA, a mobile computer, a handheld PC, an ATM, and a RTM may be applied thereto.

The authentication server 5 receives the information on the identifier 1 transmitted from the terminal 30, that is, the information on the overlapped pattern 3 and compares the received information with previously-stored information corresponding to the identifier 1, and then transmits a corresponding result value to the terminal 30. Such an authentication server 5 may be managed by a manufacturer of a product to which the identifier 1 of the present invention is attached, or by an administration server managing a number of authentication servers. For example, in case that there are provided the following products: clothes; shoes; accessories; automobiles; and mobile phones, an authentication server for the each product may be operated by a manufacturer of the product. Besides, in case that a manufacturer has a difficulty in managing an authentication server alone, the manufacture may provide an authentication service using an authentication server of an agency, and also operating the authentication server may be performed through a number of known methods, and thus the detailed description of the methods are omitted.

FIG. 9 illustrates another embodiment of the random-type multilayer identifier according to the present invention in a perspective view. As shown in FIG. 9, an identifier has an opaque portion 14 formed in a portion of the top one of identification layers in order to prevent corresponding portions of other identification layers stacked below the top one from being seen and an identification code 15 which is configured with a series of combined numbers, symbols, or characters and formed in a portion of the identification layer disposed right below the top one, and thus the genuineness of the identifier may be determined through the opaque portion and identification code. For example, when a user photographs the identifier using a camera of a terminal and transmits information on the identifier to an authentication server, the authentication server feeds product information corresponding to the transmitted information back to the terminal. Here, because the authentication server stores product information and data configuring the identification code of the corresponding identifier, a user determines whether combined characters displayed on the screen of the terminal are identical to the data configuring the identification code of the corresponding identifier by checking the stored product information and data transmitted to the corresponding terminal, and thus authenticating the identifier is performed.

1. Random-type multilayer identifier, characterized in that the identifier comprises transparent identification layers having identification patterns formed by irregularly-dispersed identification particles, wherein a unique overlapped pattern is formed by the two or more identification layers stacked each other.

2. Random-type multilayer identifier according to claim 1, characterized in that either of a resin material or a glass material, or both of the two materials is used to form the identification layer, and also the identification particle has a characteristic value configured with any one of position, color, shape, and size, or a combination thereof, and is formed out of any one or more of resin, glass, mineral, and metallic powders or in a printed manner.

3. Random-type multilayer identifier according to claim 1, characterized in that the identifier comprises an index pattern that stores index information having any one or more of product information, such as price, date of manufacture, date of expiration, name of manufacturer, description of product, and authentication server address, wherein the index pattern comprises a colored grid pattern that has color codes formed in such a manner that grid squares formed by grids are filled with two or more colors, and a reference color pattern that is disposed next to the colored grid pattern and is filled with the same colors as the colored grid pattern.

4. Random-type multilayer identifier according to claim 1, characterized in that the multiple stacked identification layers are configured in such a manner that a transparent adhesive layer is disposed between the multiple stacked identification layers so that the one identification layer is detachable from the other opposite identification layer, or a part of the identification layer is cuttable.

5. Random-type multilayer identifier according to claim 1, characterized in that any one of the multiple stacked identification layers is made out of a transparent material having a color different from the rest of the identification layers.

6. Random-type multilayer identifier according to claim 1, characterized in that the multiple stacked identification layers are formed in the same sizes, or in sizes and shapes different from each other.

7. Random-type multilayer identifier according to claim 1, characterized in that an opaque blocking layer is provided to the bottom of the identifier with the multiple stacked identification layers.

8. Random-type multilayer identifier according to claim 1, characterized in that an opaque portion is formed in a portion of the top identification layer among the multiple stacked identification layer, and an identification code configured with any one of numbers, symbols, and characters, or a combination thereof is formed in a portion of the identification layer disposed right below the top identification layer at a position corresponding to the opaque portion.

9. Authentication system using the random-type multilayer identifier, comprising:
an identifier which uses an identification pattern that is formed by irregularly-dispersed identification particles as unique information and is formed in such a manner that two or more identification layers made out of a transparent material are stacked each other;
a terminal which is used to photograph an overlapped identification pattern formed by the stacked identification layers and transmits information on the overlapped identification pattern through a wired and wireless network, and then receives result information corresponding to the transmitted information; and
an authentication server which receives the information on the overlapped identification pattern transmitted from the terminal, compares the received information with previously-stored information, and transmits a result value obtained through the comparison to the corresponding terminal.

10. Authentication system using the random-type multilayer identifier according to claim 9, characterized in that either of a resin material or a glass material, or both of the two materials is used to form the identification layer, and also the identification particle has a characteristic value configured with any one of position, color, shape, and size, or a combination thereof, and is formed out of any one or more of resin, glass, mineral, and metallic powders or in a printed manner.

11. Authentication system using the random-type multilayer identifier according to claim 9, characterized in that the identifier comprises an index pattern that stores index information having any one or more of product information, such as price, date of manufacture, date of expiration, name of manufacturer, description of product, and authentication server address, wherein the index pattern comprises a colored grid pattern that has color codes formed in such a manner that grid squares formed by grids are filled with two or more colors, and a reference color pattern that is disposed next to the colored grid pattern and is filled with the same colors as the colored grid pattern.

12. Authentication system using the random-type multilayer identifier according to claim 9, characterized in that the multiple stacked identification, layers are configured in such a manner that a transparent adhesive layer is disposed between the multiple stacked identification layers so that the one identification layer is detachable from the other opposite identification layer, or a part of the identification layer is cuttable.

13. Authentication system using the random-type multilayer identifier according to claim 9, characterized in that any one of the multiple stacked identification layers is made out of a transparent material having a color different from the rest of the identification layers.

14. Authentication system using the random-type multilayer identifier according to claim 9, characterized in that the multiple stacked identification layers are formed in the same sizes, or in sizes and shapes different from each other.

15. Authentication system using the random-type multilayer identifier according to claim 9, characterized in that an opaque blocking layer is provided to the bottom of the identifier with the multiple stacked identification layers.

16. Authentication system using the random-type multilayer identifier according to claim 9, characterized in that an opaque portion is formed in a portion of the top identification layer among the multiple stacked identification layer, and an identification code configured with any one of numbers, symbols, and characters, or a combination thereof is formed in a portion of the identification layer disposed right below the top identification layer at a position corresponding to the opaque portion.

17. Authentication system using the random-type multilayer identifier according to claim 9, characterized in that the terminal comprises a camera module which is used to photograph an image of the identification pattern, a microcomputer module which is connected to the camera module and reads and analyzes the photographed image to convert the analyzed image into data, and a wired and wireless communication module which is connected to the microcomputer module, and receives/transmits the data as well as receives a result value corresponding to the data to feed the result value back to the microcomputer module, wherein the terminal may be any one of a mobile communication terminal, a Personal Computer (PC), a Personal Digital Assistant (PDA), a mobile computer, a handheld PC, an Automated Teller Machine (ATM), and a Retail Teller Machine (RTM).
